(19) United States
(12) Patent Application Publication
(10) Pub. No.: US 2006/0054832 A1
(43) Pub. Date: Mar. 16, 2006

(54) Detector, having a detector housing and a plurality of detector modules, and computed tomograph having such a detector

(76) Inventors: Markus Cambensi, Forchheim (DE); Helmut Lutz, Hausen (DE); Claus Pohan, Baiersdorf (DE)

Correspondence Address: HARNESS, DICKEY & PIERCE, P.L.C., P.O.BOX 8910, RESTON, VA, 20195, US

(21) Appl. No.: 11/224,079

(22) Filed: Sep. 13, 2005

(30) Foreign Application Priority Data
Sep. 14, 2004 (DE) 10 2004 044 901.5

(51) Int. Cl. G01T 1/20

(52) U.S. Cl. 250/370.11

(57) ABSTRACT

A detector is disclosed which includes a detector housing and a plurality of detector modules. Further, a computed tomograph is disclosed which has such a detector associated with it. The detector housing includes a stop device on the housing and at least one respective detector module includes a stop device on the module for orienting the detector modules relative to one another. The stop device on the housing and the stop device on the module bear against one another in the oriented state such that the detector modules are oriented relative to one another in precise form with respect to a system axis of the detector.

The present application hereby claims priority under 35 U.S.C. §119 on German patent application number DE 10 2004 044 901.5 filed Sep. 14, 2004, the entire contents of which is hereby incorporated herein by reference.

### FIELD

The invention generally relates to a detector having a detector housing and a plurality of detector modules. The invention also generally relates to a computed tomograph having such a detector.

### BACKGROUND

DE 101 38 913 A1 discloses a detector for a computed tomograph having a plurality of detector modules retained on a detector housing. Each detector module includes a detector element array which is formed from detector elements and which is mounted on a component support. The detector modules are arranged next to one another in the direction of rotation around a system axis of the computed tomograph. Just a slight geometric offset in the detector modules relative to the system axis causes interference in the X-ray image detected by the detector.

In the case of known detectors for computed tomographs, the detector housing therefore has fitting pins on it, on the one hand, and the respective component support of the detector modules has corresponding fitting holes on it, on the other hand, so that when the connection is made between the detector housing and the detector modules the detector modules are oriented among one another in the direction of the system axis. In addition, it is possible to use “groove/spring connections” instead of the fitting pins and fitting holes, said connections respectively producing a connection between the detector housing and the respective detector module via the latter's collimator.

Despite these measures, the detector modules can have a geometric offset, for example as a result of play between the fitting pin and the hole or as a result of a clearance between the groove and the article holding the groove. Thus, interference can arise in the X-ray image detected by the detector.

### SUMMARY

An object of at least one embodiment of the present invention to design a detector including a plurality of detector modules such that the detector modules can easily be oriented relative to one another.

At least one object may be achieved by a detector and/or by a computed tomograph having such a detector. Advantageous refinements of the detector are further respectively covered.

In accordance with at least one embodiment of the invention, the detector includes a detector housing and a plurality of detector modules, where the detector housing has a stop device on the housing and the respective detector module has a stop device on the module for the purpose of orienting the detector modules relative to one another, the stop device on the housing and the stop device on the module bearing against one another in the oriented state.

The inventive detector of at least one embodiment allows precise and nevertheless simple orientation of the detector modules relative to one another by virtue of all detector modules having a defined, standard situation relative to one another as a result of the stop device on the module being applied to the stop device on the housing. The direct application of the detector modules to a stop device associated with the detector housing avoids possible tolerances for the arrangement between the components.

At least one embodiment of the invention also makes it possible for precise orientation between a collimator and a detector element array using a stop device on the collimator and a stop device on the detector element, the two stop devices bearing against one another in the oriented state. Preferably, the respective detector element array has a scintillator which has the detector element's stop device associated with it, so that precise orientation can be produced directly between the collimator and the scintillator or the detector element array directly associated therewith. Preferably, the collimator additionally has the module's stop device associated with it.

This ensures that all detector element arrays can easily be oriented relative to the detector housing indirectly by the collimator. By applying the scintillator to the collimator, on the one hand, and applying the collimator to the detector housing, on the other, any offset between the detector element arrays is avoided.

The stop device can be produced with little complexity. The common stop device on the housing can be produced by a simple milling operation, for example. The stop device on the collimator and the stop device on the module can easily be produced together by way of injection molding in connection with the collimator. There is thus no need for complex and cost-intensive manufacturing processes, as is the case when fitting pins and fitting holes or groove/spring connections are used, for example.

Advantageously, at least one of the stop device has a stop edge. Such a stop device in the form of a stop edge is particularly easy to include in a design of the detector. A stop device which can likewise be manufactured with little complexity is a stop device in the form of a stop face.

In a further advantageous refinement of at least one embodiment of the invention, a computed tomograph can be designed with the inventive detector.

### BRIEF DESCRIPTION OF THE DRAWINGS

Example embodiments of the invention and other advantageous refinements of the invention are shown in the schematic drawings below, in which:

FIG. 1 shows a computed tomograph partly in a block diagram view and partly in a perspective view,

FIG. 2 shows a sectional illustration of an inventive detector of at least one embodiment, having a stop device on the housing and a stop device on the module in a stop position,

FIG. 3 shows the detector module from FIG. 2 with a stop device on the collimator and a stop device on the detector element in a stop position, and

FIG. 4 shows the detector from FIG. 2 in a plan view.

### DETAILED DESCRIPTION OF THE EXAMPLE EMBODIMENTS

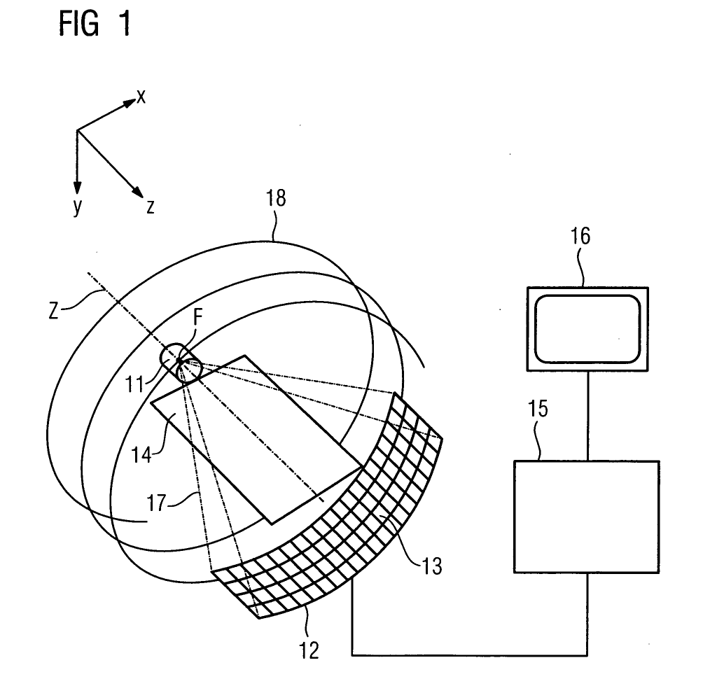

FIG. 1 shows a computed tomograph partly in a perspective illustration and partly in a block diagram illustration. The computed tomograph includes a recording system 11, 12 with an X-ray source 11 and a CT detector 12 which has CT detector elements 13 arranged in a detector element array to form columns and rows, a processing device 15 for reconstructing layer or volume images, and a display unit 16 for displaying the layer or volume images.

The X-ray source 11 and the CT detector 12 are fitted opposite one another on a detector housing (not shown) such that during operation of the computed tomograph an X-ray beam emerging from a focus F of the X-ray source 11 and bounded by marginal beams 17 hits the CT detector 12.

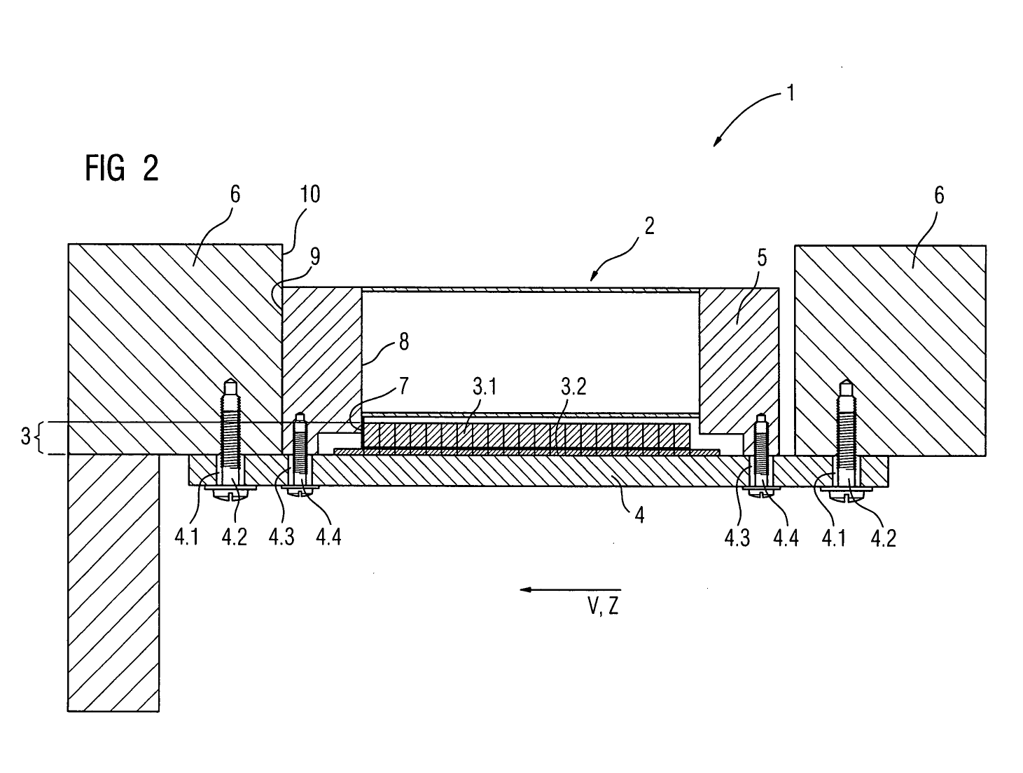

The detector housing, which may simultaneously also be in the form of a rotating frame, can be rotated around a system axis Z by way of a driving device (not shown). In this case, the system axis Z runs parallel to the z axis of a spatial rectangular coordinate system which is shown in FIG. 1. For a recording area on a patient (not shown) laid on a patient's table 14, this method can be used to produce X-ray images from different projection directions or rotation angle positions in order to reconstruct a plurality of layer images. In this case, the recording area is scanned by continuously advancing the patient's couch 14 in the direction of the z axis and rotating the recording system 11, 12 around the recording area to be examined in the form of a spiral scan 18. By way of example, an inventive detector 1 as shown in FIGS. 2 to 4 may be used for such a computed tomograph.

FIG. 2 shows a sectional illustration of an inventive detector of at least one embodiment for a computed tomograph as shown in FIG. 1 with a detector housing 6 and a plurality of detector modules 2, one of which can be seen in the view. The respective detector module 2 includes a collimator 5, a detector element array 3, which is formed from a scintillator 3.1 and a photodiode array 3.2, and a component support 4 on which the collimator 5 and the detector element array 3 are arranged. The detector housing 6 has a stop device 10 on the housing and the respective detector module 2 has a stop device 9 on the module in the form of a stop face, the module's stop device 9 being associated with the collimator 5. The detector module 2 and the detector housing 6 are shown in a state where they are oriented relative to one another and in which the two stop device 9, 10 bear directly against one another.

For orientation purposes, it is possible to undo a first screw connection 4.1, 4.2 provided on the housing, so that some play in a first screw 4.2 relative to a first hole 4.1 on the component carrier 4 in the case of the first screw connection 4.1, 4.2 allows the detector module 2 to be shifted in a stop direction V which is shown in the drawing such that the two stop devices 9, 10 bear directly against one another. In this case, the stop direction V runs parallel to a system axis Z which is present in the computed tomograph. In this oriented state between the detector module 2 and the detector housing 6, the position of these two components can then be secured by tightening the first screw 4.2.

In addition, the detector also has a stop device 8 on the collimator and a stop device 7 on the detector element in the form of a stop edge, so that a standard orientation for the detector element array 3 relative to the respective collimator 5 is possible. In the example shown, the stop device 7 on the detector element is associated with the scintillator 3.1.

To orient these two components of the detector, it is possible to undo a second screw connection 4.3, 4.4 on the collimator, so that, as has also already been explained for the orientation of the collimator 5 relative to the detector housing 6, some play in a second screw 4.4 relative to a second hole 4.3 on the component support 4 in the case of the second screw connection 4.3, 4.4 allows the component support 4 to be shifted in a stop direction V which is shown in the drawing such that the two stop devices 7, 8 bear directly against one another.

The respective stop device provided between the detector housing 6 and the collimator 5, on the one hand, and the stop device between the collimator 5 and the detector element array 3, on the other hand, mean that the detector element arrays 3 from various detector modules 2 can be oriented precisely in the direction of the system axis Z.

In the case of the detector shown, the individual components are typically oriented in two successive operating steps:

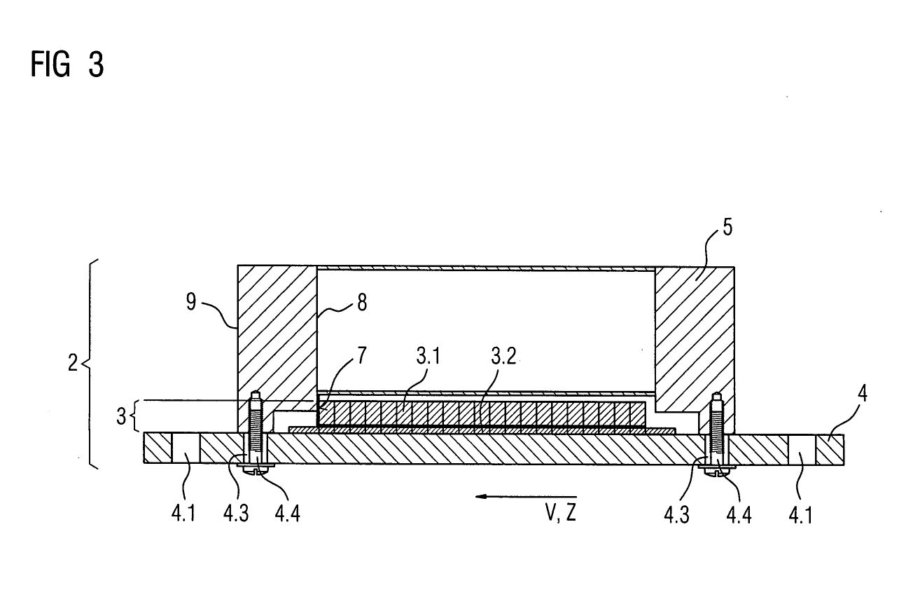

In the first operating step, as FIG. 3 shows, the collimator 5 is oriented relative to the detector element array 3. For this purpose, the second screw connection 4.3, 4.4 is undone, so that when there is some play between the second hole 4.4 and the second screw 4.3, the component support 4 is shifted toward the collimator's stop edge 8 in the stop direction V shown in the drawing as far as the stop at the detector element's stop edge 7. In the oriented state between the collimator 5 and the detector element array 6, the second screw connection 4.3, 4.4 is secured again.

In the second operating step, the detector module 2 is then oriented relative to the detector housing 6. For this purpose, the first screw connection 4.1, 4.2 is undone, so that when there is some play between the first hole 4.2 and the first screw 4.1 the detector module 2 is shifted toward the housing's stop edge 10 in the stop direction V shown in the drawing as far as the stop at the module's stop edge 9. In the oriented state between the detector housing 6 and the detector module 2, the first screw connection 4.1, 4.2 is then secured again.

The stop devices 7, 8, 9 on the detector module which are shown in the example do not necessarily have to be associated with the collimator 5 or with the scintillator 3.1. By way of example, this may be done by providing components provided specifically for this purpose on the respective detector module 2 which serve exclusively as stop device and to orient the modules. In addition, the invention is not limited to detectors which operate on the basis of scintillators. It is likewise possible to use semiconductor detectors which allow direct conversion of the X-ray radiation acting on a detector element.

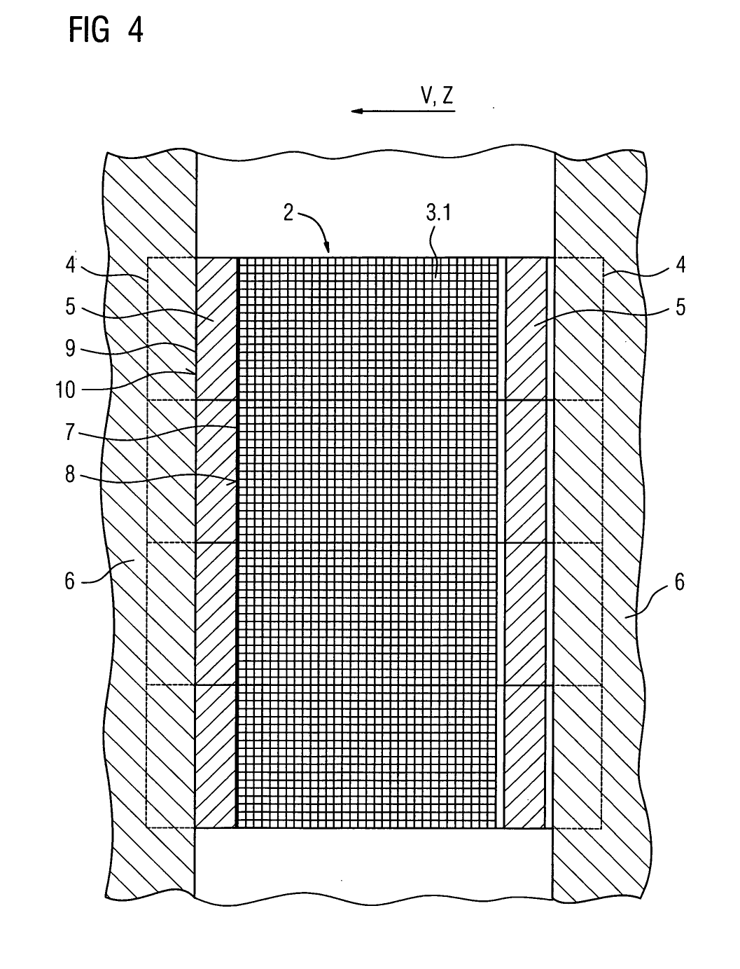

FIG. 4 shows the inventive detector in a plan view. The detector modules 2 are arranged next to one another in the direction of rotation of the detector 1 around the system axis Z of the computed tomograph such that detector lines are formed from detector elements of adjacent detector modules 2 in the direction of rotation. For the purpose of simple illustration, only one detector module 2 is provided with reference symbols. As a result of the orientation of the detector element array 3 relative to the collimator 5 and relative to the detector housing 6 on the basis of the stop device 9, 10, the lines have no offset. Thus, it is possible to achieve improved quality for the images detected by the detector.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A detector, comprising:
a detector housing including a stop device on the housing; and
a plurality of detector modules, each including a stop device on the module for orienting the detector modules relative to one another, the stop device of the housing and the stop device of the module bearing against one another in the oriented state.

2. The detector as claimed in claim 1, wherein a respective detector module includes a collimator and a detector element array, the collimator including a stop device on the collimator and the detector element array including a stop device on the detector element for orienting the collimator and the detector element array relative to one another, the two stop devices of the collimator and the detector element array bearing against one another in the oriented state.

3. The detector as claimed in claim 2, wherein the detector element array includes a scintillator, and wherein the scintillator includes the stop device on the detector element.

4. The detector as claimed in claim 2, wherein the collimator includes the stop device on the module.

5. The detector as claimed in claim 1, wherein at least one of the stop devices is a stop edge.

6. The detector as claimed in claim 1, wherein at least one of the stop devices is a stop face.

7. The detector as claimed in claim 1, wherein at least one of the stop devices is produced by milling.

8. A computed tomograph having a detector as claimed in claim 1.

9. The detector as claimed in claim 3, wherein the collimator includes the stop device on the module.

10. The detector as claimed in claim 2, wherein at least one of the stop devices is a stop edge.

11. The detector as claimed in claim 3, wherein at least one of the stop devices is a stop edge.

12. The detector as claimed in claim 2, wherein at least one of the stop devices is a stop face.

13. The detector as claimed in claim 3, wherein at least one of the stop devices is a stop face.

14. The detector as claimed in claim 5, wherein at least one of the stop devices is a stop face.

15. The detector as claimed in claim 2, wherein at least one of the stop devices is produced by milling.

16. The detector as claimed in claim 3, wherein at least one of the stop devices is produced by milling.

17. A computed tomograph having a detector as claimed in claim 2.

18. A computed tomograph having a detector as claimed in claim 3.
